(19) United States
(12) Patent Application Publication
(10) Pub. No.: US 2018/0099172 A1
(43) Pub. Date: Apr. 12, 2018

(54) EXERCISE DEVICE

(71) Applicant: GUI GLOBAL PRODUCTS, LTD., Houston, TX (US)

(72) Inventor: Walter G. Mayfield, Houston, TX (US)

(73) Assignee: GUI GLOBAL PRODUCTS, LTD., Houston, TX (US)

(21) Appl. No.: 15/721,191

(22) Filed: Sep. 29, 2017

Related U.S. Application Data
(63) Continuation of application No. 14/785,275, filed on Oct. 16, 2015, now abandoned.

(51) Int. Cl. A63B 21/02; A63B 24/00; A63B 21/00; A63B 21/06; A63B 21/072; A63B 23/035; A63B 23/12; A63B 71/06; H04M 1/725; A63B 21/16; A63B 21/008; A63B 21/015; A63B 71/00

(52) U.S. Cl. CPC A63B 21/023; A63B 2071/0072; A63B 21/4043; A63B 21/00043; A63B 21/025; A63B 21/06; A63B 21/0608; A63B 21/072; A63B 21/153; A63B 23/03508; A63B 23/12; A63B 23/1209; A63B 21/4035; A63B 2071/0627; H04M 1/7253; A63B 21/1618; A63B 21/16; A63B 21/0088; A63B 21/015; A63B 2071/0652; A63B 2071/0655; A63B 2071/0694; A63B 2220/30; A63B 2220/40; A63B 2220/62; A63B 2220/803; A63B 2220/833; A63B 2225/20; A63B 2225/50; A63B 2225/54; A63B 24/0062

(57) ABSTRACT

An apparatus for exercising uses one or more spring member that provide a constant force. The apparatus may include one or more grips, tethers, and spring elements that are either connected or secured to one another. The apparatus may also use a free floating object.

### CROSS-REFERENCE TO RELATED APPLICATION

This application claims priority from U.S. patent application Ser. No. 14/785,275 filed on Oct. 16, 2015, which is a 371 National Phase Entry of International Application No.: PCT/US2014/034006, filed Apr. 14, 2014, which claims priority from U.S. Provisional Application Ser. No. 61/813,486, filed on Apr. 18, 2013 the entire disclosure of which is incorporated herein by reference in its entirety.

### BACKGROUND OF THE DISCLOSURE

### 1. Field of Disclosure

The present disclosure relates to a devices and methods for strengthening and conditioning muscles and relate.

### 2. The Related Art

Traditional devices used for strengthening and conditioning muscles tend to apply a non-constant resistive force during a given exercise movement. For example, the resistive force may be increase during a movement, decrease during a movement, or increase/decrease at either the beginning or end of a movement. Moreover, these devices tend to be bulky and require floor space during use.

The present disclosure addresses these and other drawbacks of the prior art.

### SUMMARY OF THE DISCLOSURE

In one aspect, the present disclosure provides an apparatus for exercising that includes a first grip; a first spring member and a second spring member connected to the first grip; a second grip; a third spring member and a fourth spring member connected to the second grip; a first tether connecting the first spring member to the third spring member; and a second tether connecting the second spring member to the fourth spring member. The spring members each include a constant force spring element.

In another aspect, the present disclosure provides an apparatus for exercising that includes a grip; a spring member secured to the grip; and a tether connecting to the spring member to an object. The spring member may include a constant force spring element.

In another aspect, the present disclosure provides an apparatus for exercising that includes a grip; a first tether connected to the grip; a spring member connected to the first tether, wherein the spring member includes a constant force spring element; and a second tether connecting the spring member to an object, wherein the spring member substantially balances a tension in the first and the second tether.

In another aspect, the present disclosure provides an apparatus for exercising that includes a grip; a tether associated with the grip; and a spring element associated with the tether and connected to a free floating object, wherein the object has a mass selected to provide a gravitational force substantially similar to a force applied by the spring element to the tether, and wherein the spring member includes a constant force spring element.

In another aspect, the present disclosure provides methods for exercising that utilize the above-described devices.

The above-recited example of features of the disclosure have been summarized rather broadly in order that the detailed description thereof that follows may be better understood, and in order that the contributions to the art may be appreciated. There are, of course, additional features of the disclosure that will be described hereinafter and which will form the subject of the claims appended hereto.

### BRIEF DESCRIPTION OF THE DRAWINGS

For detailed understanding of the present disclosure, references should be made to the following detailed description of the preferred embodiment, taken in conjunction with the accompanying drawings listed below:

FIG. 1 illustrates one embodiment of an exercise device according to the present disclosure;

FIG. 2 illustrates a side view of the FIG. 1 embodiment;

FIGS. 3A-3B illustrates one use of the FIG. 1 embodiment;

FIGS. 4A-4B illustrates another use of the FIG. 1 embodiment;

FIG. 5 illustrates an embodiment of an exercise device that uses two spring members;

FIG. 6 illustrates an embodiment of an exercise device wherein the grips are attached to the tethers;

FIG. 7 illustrates an embodiment of an exercise device that uses one spring member;

FIG. 8 illustrates an embodiment of an exercise device uses a free floating object;

FIG. 9 illustrates an embodiment of an exercise device that uses a torsion spring; and

FIG. 10 illustrates an embodiment of an exercise device that uses a spring element as a tether.

### DETAILED DESCRIPTION OF THE DISCLOSURE

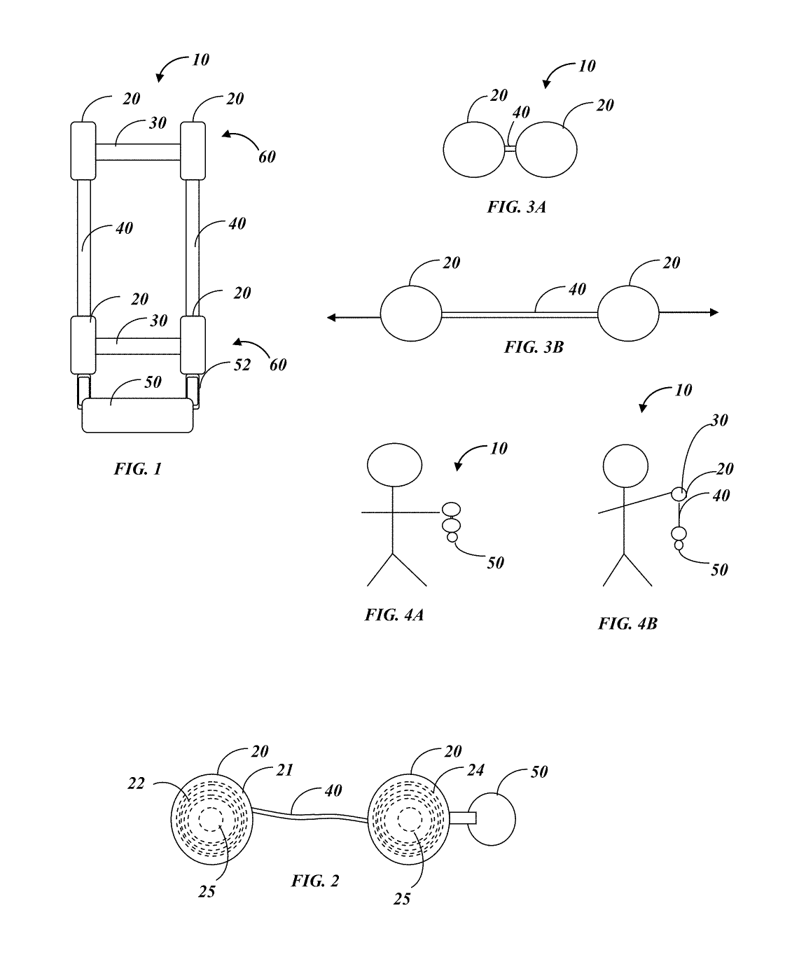

Referring to FIG. 1, there is shown one embodiment of a exercise device 10 that may be used for aerobic and/or anaerobic exercises. These exercises may be used to improve endurance, flexibility, strength, condition, etc. The exercise device 10 may include a spring members 20, handles 30, and tethers 40. Optionally, a weight 50 may be selectively connected to the exercise device 10 with a connector 52. As will be apparent from the discussion below, the exercise device 10 counteracts the motion of a user with a constant force (e.g., torque or tension). The motion may be a repetitive movement of a bodily limb such as an arm, trunk, or leg. The constant force enables the user to experience a relatively constant resistance to movement over the entire range of movement. That is, the force encountered at the beginning or end of a movement is substantially the same as that encountered during the middle of the movement. For purposes of this disclosure, a variance of 40% or less is considered steady or constant.

The constant force may be generated using the spring members 20. Referring to FIG. 2, the spring members 20 may include a case or housing 21 that includes coil springs 22 wound around an axle 25. The coil spring 22 may be a pre-stressed flat strip of spring material (e.g., spring steel). The tether 40 is wound around the axle 25 such that unwinding the tether 40 causes the coil spring 22 to elastically deform (e.g., wind or unwind). For instance, the unwinding of the coil spring 22 applies a tension force to the tether 40 that resists the unwinding of the tether 40. A coil is only one illustrative spring that may be used to provide a constant force or torsion during use. Other suitable springs include torsion springs. Embodiments using the spring member 20 are discussed below.

Referring to FIG. 1, in one arrangement, the exercise device 10 includes two sets of spring members 20. Each set 60 includes two spring members 20 secured to a grip 30. The grip 30 may be a loop, bar, ring, handle or other structural element that is shaped and sized to be grasped or otherwise manipulated by a user. The grip 30 may be rigid or pliant. Opposing spring members 20 of each set 60 are connected to one another by the tethers 40. The tethers 40 may be shaped as a ribbon, wire, cable, tape, string, cord or other non-rigid member than may be spooled and unspooled from an axle. Suitable materials for the tether 40 include, but are not limited to, pliable materials such as a plastic (e.g., nylon), cotton, twine, etc. Pulling the handles 30 apart unwinds the tether 40. As the tether 40 unwinds, the coil spring members 20 are activated; e.g., wind or unwind. When activated, the spring members apply a constant tension that resists the pulling action.

In embodiments of the present disclosure, two spring members 20 may be connected to a common tether 40. As shown in FIG. 3A, in a relaxed state, the tether 40 is mostly wound on the axles 25 (FIG. 2) of the spring member 20. Thus, the exercise device is in an axially compact condition. As shown in FIG. 3B, when the spring members 20 are pulled apart, the tether 40 unwinds, but the coil springs 22 (FIG. 2) of each spring member 20 resist the pulling action with a constant tension applied to the tether 40.

Referring now to FIGS. 4A and B, there is shown the use of the exercise device 10 that is used in conjunction with a free floating weight 50. In FIG. 4A, the user is shown holding the exercise device 10 stationary. When held stationary, the exercise device 10 is in a compact condition. It should be noted that the spring force of the spring member 20 is sufficiently strong to maintain the tether 40 wound on the axle 25 (FIG. 2) even though the mass of the weight 50 is acting on the tether 40. In one sense, the spring force counterbalances the gravitational force applied by the weight 50. In FIG. 4B, the user applies an upward force to the upper grip 30. This upward force unwinds the tether 40. Because the upper grip 30 is secured to the spring member 20, the upper grip 30 and the spring member 20 move as an integral unit. The weight 30 applies a constant static downward force due to gravity as discussed previously. At the same time, the spring members 20 each apply a constant tension force due to the coil springs 22 (FIG. 2) that allows the tether 40 to unwind. That is, the spring force is selected to allow the tether 40 to unwind when the grip 30 is pressed upward by the user. Thus, in one embodiment, the spring force or tension applied by the spring member 20 has an upper limit and a lower limit. That is, the spring force is strong enough to maintain the tether 40 in a wound condition while in a static state but weak enough to allow the tether 40 to unwind while in a dynamic state.

It should be further appreciated that the exercise device 10 enables the user to practice controlled explosive movement. For example, as shown in FIG. 4B, the user may perform repetitive movements by applying an upward force to the grip 30, but control the upward force to maintain the weight 50 in a mostly stationary position.

It should be appreciated that exercise devices according to the present disclosure may be susceptible to numerous variations. Some non-limiting embodiments are discussed below.

Referring now to FIG. 5, there is shown another embodiment of the present disclosure. In this embodiment, the exercise device 10 has only one set of spring members 20 that are connected by the tether 40. Each spring member 20 is secured to an associated grip 30.

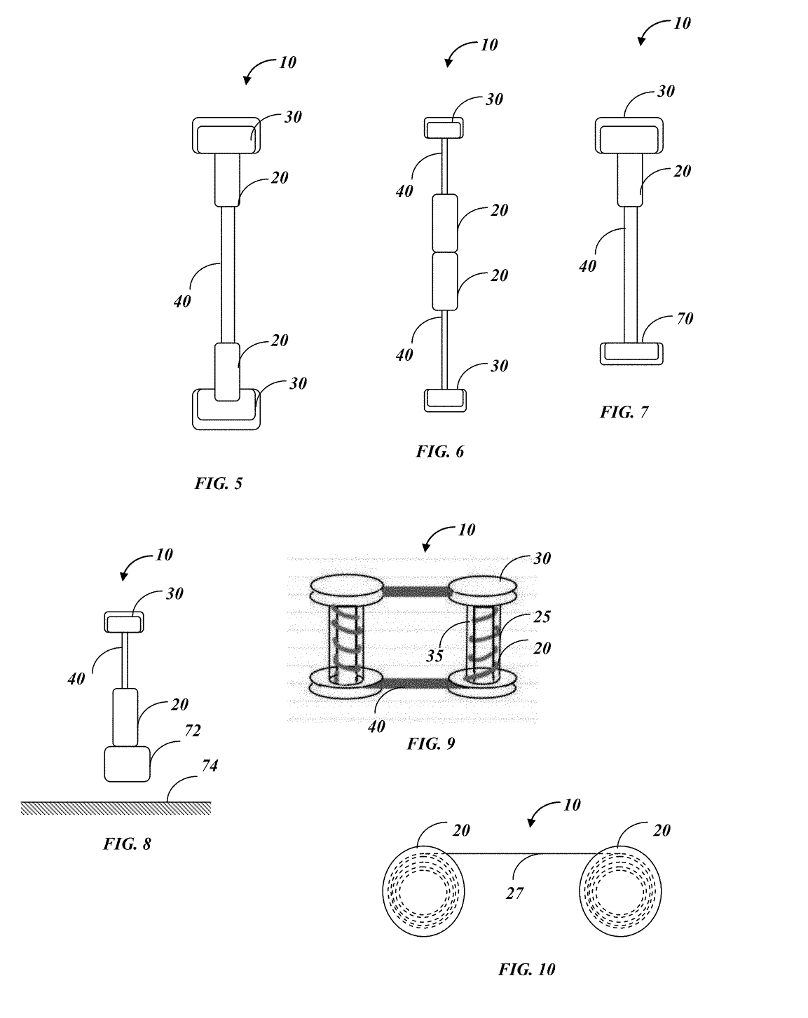

Referring now to FIG. 6, there is shown another embodiment of the present disclosure. In this embodiment, the exercise device 10 has two spring members 20 that are secured to one another. Each spring member 20 is connected to a tether 40 that is secured to a grip 30.

Referring now to FIG. 7, there is shown another embodiment of the present disclosure. In this embodiment, the exercise device 10 has one spring member 20 that is fixed to a grip 30. The spring member 20 has a tether 40 that includes an anchor 70. The anchor 70 may be attached to furniture, a door, or other structural feature.

Referring now to FIG. 8, there is shown another embodiment of the present disclosure. In this embodiment, the exercise device 10 has a grip 30 that is connected to a spring member 20 by a tether 40. The spring member 20 is secured to an object 72 that acts as a counterweight. Further, the object 72 is free standing. In this context, the term “free standing” means that the entire weight of the object 72 is supported at the grip 30 and none of the weight is supported by another structure such as a surface 74, which is physically separated from the object 72. Because the object 72 is secured to the spring member 20, the object 72 and the spring member 20 move as an integral unit.

It should be appreciated that the spring members may incorporate any known mechanism for applying a constant force to a tether. Further, certain structural features may be formed as integral devices. For instance, referring to FIG. 9, there is shown an exercise device 10 that combines the grip 30 with the spring member 20, which uses a torsion spring 25. The torsion spring 25 is integrated into an axle 35 of the grip 30. As the tether 40 unwinds from the axle 35, the torsion spring 25 generates a resistive constant tension force.

Referring now to FIG. 10, there is shown another embodiment wherein structural features are combined. In FIG. 10, an exercise device 10 includes a spring member 20 that uses a coil spring 27. However, the coil spring 27 is used to connect the two spring members 20. Thus, the coil element of the coil spring 27 functions as the tether 40 shown in the other embodiments of the present disclosure.

As used above, the term “secured to” or “fixed to” refers to a connection that prevents relative movement between two features. The term “connected to” refers to a connection that only limits relative movement between two features. For example, in FIG. 5, the grips 30 and the spring members 20 are secured to one another. Thus, there is no relative movement between these two features. The tether 40 connects the two spring members 20. Thus, the two spring members 20 have some relative freedom of movement.

From the above, it should be appreciated that what has been disclosed includes an apparatus for exercising. The apparatus may include a first grip; a first spring member and a second spring member connected to the first grip; a second grip; a third spring member and a fourth spring member connected to the second grip; a first tether connecting the first spring member to the third spring member; and a second tether connecting the second spring member to the fourth spring member. The spring members each include a constant force spring element.

From the above, it should be appreciated that what has been disclosed also includes a method for exercising. The method includes (i) providing an exercise device that has: a first grip; a first spring member and a second spring member connected to the first grip; a second grip; a third spring member and a fourth spring member connected to the second grip; a first tether connecting the first spring member to the third spring member; and a second tether connecting the second spring member to the fourth spring member, wherein the spring members each include a constant force spring element; and (i) pulling the first grip away from the second grip.

From the above, it should be appreciated that what has been disclosed further includes an apparatus for exercising. The apparatus may include a grip; a spring member secured to the grip; and a tether connecting to the spring member to a object. The spring member may include a constant force spring element.

From the above, it should be appreciated that what has been disclosed also includes an apparatus for exercising. The apparatus may include a grip; a first tether connected to the grip; a spring member connected to the first tether, wherein the spring member includes a constant force spring element; and a second tether connecting the spring member to an object, wherein the spring member substantially balances a tension in the first and the second tether.

From the above, it should be appreciated that what has been disclosed also includes an apparatus for exercising. The apparatus may include a grip; a tether associated with the grip; and a spring element associated with the tether and connected to a free floating object, wherein the object has a mass selected to provide a gravitational force substantially similar to a force applied by the spring element to the tether, and wherein the spring member includes a constant force spring element.

The foregoing description is directed to particular embodiments of the present disclosure for the purpose of illustration and explanation. It will be apparent, however, to one skilled in the art that many modifications and changes to the embodiment set forth above are possible without departing from the scope of the disclosure. Thus, it is intended that the following claims be interpreted to embrace all such modifications and changes.

1. An apparatus for exercising, comprising:
a compact gripping assembly including:
at least one spring member which is a flat coiled spring configured to deliver a substantially constant force;
a grip fixed and stationary to the at least one spring member;
at least one tether connected to the at least one spring member, wherein the tether winds around the at least one spring member;
an object connected to the tether, the tether being configured to unspool out of the gripping assembly as the distance separating the object and the gripping assembly increases; and
the at least one spring member and the tether are concentric and wind along the same longitudinal plane;
wherein the object is a second gripping assembly substantially similar to the gripping assembly and the at least one spring member of the gripping assembly includes two spring members, the two spring members being configured to wind independently of one another.

2. The apparatus of claim 1, wherein the grip of the gripping assembly connects the two spring members of the gripping assembly, and wherein the grip of the second gripping assembly connects the two spring members of the second gripping assembly.

3. The apparatus of claim 1, wherein the grip of the gripping assembly encloses the at least one spring member of the gripping assembly, and wherein the grip of the second gripping assembly encloses the at least one spring member of the second gripping assembly.

4. The apparatus of claim 1, wherein the at least one spring member of the gripping assembly and the second gripping assembly is a flat coiled spring wound around an axle and within a spool holding the tether.

5. A method for exercising, comprising:
a human applying a force to the gripping assemblies of the compact apparatus of claim 1 by gripping the gripping assemblies and spreading apart the arms, wherein the applied force unspools the tether and increases a distance separating the object and the gripping assemblies; and
as the arc of the arms reaches the apex of spreading motion, allowing the arms to come to a stop;
wherein the spreading apart of the arms is done under substantially continuous resistive force from the compact apparatus and the compact aspect of the compact apparatus has minimal mass thereby allowing the human to experience substantially no negative force due to inertia at the apex of the spreading motion arc.

7. An apparatus for exercising, comprising:
a compact gripping assembly including:
at least one spring member, the at least one spring member being a flat coiled spring configured to deliver a substantially constant force, and
a grip fixed and stationary to the at least one spring member; and
at least one tether connected to the at least one spring member, wherein the tether winds around the longitudinal axis of the at least one spring member; and
an object connected to the tether, the tether being configured to unspool out of the gripping assembly as the distance separating the object and the gripping assembly increases; and [symbol]
